(19) United States
(12) Patent Application Publication
(10) Pub. No.: US 2024/0086424 A1
(43) Pub. Date: Mar. 14, 2024

(54) INFORMATION PROCESSING SYSTEM, INFORMATION PROCESSING METHOD, AND COMPUTER PROGRAM

(71) Applicant: NEC Corporation, Minato-ku, Tokyo (JP)

(72) Inventors: Taiki MIYAGAWA, Tokyo (JP); Akinori EBIHARA, Tokyo (JP)

(73) Assignee: NEC Corporation, Minato-ku, Tokyo (JP)

(21) Appl. No.: 18/272,959

(22) PCT Filed: Jan. 25, 2021
(86) PCT No.: PCT/JP2021/002439

§ 371 Date: Jul. 18, 2023

(51) Int. Cl. G06F 16/28; G06F 17/18

(52) U.S. Cl. CPC G06F 16/285; G06F 17/18

(57) ABSTRACT

An information processing system includes: an acquisition unit that obtains a plurality of elements included in series data; a calculation unit that calculates a likelihood ratio indicating a likelihood of a class to which the series data belong, on the basis of at least two consecutive elements of the plurality of elements; a classification unit that classifies the series data into at least one class of a plurality of classes that are classification candidates, on the basis of the likelihood ratio; and a learning unit that performs learning related to calculation of the likelihood ratio, by using a loss function of a log-sum-exp type. According to such an information processing system, it is possible to properly select the class to which the series data belong, from a plurality of classes that are classification candidates.

### TECHNICAL FIELD

This disclosure relates to technical fields of an information processing system, an information processing method, and a computer program that process information about class classification, for example.

### BACKGROUND ART

A known system of this type performs class classification of data. For example, Patent Literature 1 discloses a technique/technology of classifying series data into any of a plurality of classes set in advance, by sequentially obtaining and analyzing a plurality of elements included in the series data. Patent Literature 2 discloses that a movement trajectory included in an image subset is classified into subclasses and the same subclass label is given to those having a high sharing ratio of the subclasses, thereby to perform the class classification of each of the subclasses.

As another related technique/technology, for example, Patent Literature 3 discloses that a process is repeated to minimize an evaluated value G=sum {(c−exp(a×log(X))+b−y)²×wp}, thereby to optimize a coefficient. Patent Literature 4 discloses that a parameter is updated such that a loss function including a log likelihood ratio is small, thereby to optimize the parameter of an identification apparatus.

### CITATION LIST

### Patent Literature

Patent Literature 1: International Publication No. WO2020/194497
Patent Literature 2: International Publication No. WO2012/127815
Patent Literature 3: JP2017-049674A
Patent Literature 4: JP2007-114413A

### SUMMARY

### Technical Problem

This disclosure aims to improve the related techniques/technologies described above.

### Solution to Problem

An information processing system according to an example aspect of this disclosure includes: an acquisition unit that obtains a plurality of elements included in series data; a calculation unit that calculates a likelihood ratio indicating a likelihood of a class to which the series data belong, on the basis of at least two consecutive elements of the plurality of elements; a classification unit that classifies the series data into at least one class of a plurality of classes that are classification candidates, on the basis of the likelihood ratio; and a learning unit that performs learning related to calculation of the likelihood ratio, by using a loss function of a log-sum-exp type.

An information processing method according to an example aspect of this disclosure includes: obtaining a plurality of elements included in series data; calculating a likelihood ratio indicating a likelihood of a class to which the series data belong, on the basis of at least two consecutive elements of the plurality of elements; classifying the series data into at least one class of a plurality of classes that are classification candidates, on the basis of the likelihood ratio; and performing learning related to calculation of the likelihood ratio, by using a loss function of a log-sum-exp type.

A computer program according to an example aspect of this disclosure operates a computer: to obtain a plurality of elements included in series data; to calculate a likelihood ratio indicating a likelihood of a class to which the series data belong, on the basis of at least two consecutive elements of the plurality of elements; to classify the series data into at least one class of a plurality of classes that are classification candidates, on the basis of the likelihood ratio; and to perform learning related to calculation of the likelihood ratio, by using a loss function of a log-sum-exp type.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation of a classification apparatus in the information processing system according to the first example embodiment.

FIG. 4 is a flowchart illustrating a flow of operation of a learning unit in the information processing system according to the first example embodiment.

FIG. 5 is a flowchart illustrating a flow of operation of a learning unit in an information processing system according to a second example embodiment.

FIG. 6 is a matrix diagram illustrating an example of likelihood ratios to be considered by the learning unit in the information processing system according to the second example embodiment.

FIG. 7 is a flowchart illustrating a flow of operation of a learning unit in an information processing system according to a third example embodiment.

FIG. 8 is a flowchart illustrating a flow of operation of a learning unit in an information processing system according to a fourth example embodiment.

FIG. 9 is a matrix diagram illustrating an example of the likelihood ratios to be considered by the learning unit in the information processing system according to the fourth example embodiment.

FIG. 10 is a block diagram illustrating a functional configuration of an information processing system according to a seventh example embodiment.

FIG. 11 is a flowchart illustrating a flow of operation of a classification apparatus in the information processing system according to the seventh example embodiment.

FIG. 12 is a block diagram illustrating a functional configuration of an information processing system according to an eighth example embodiment.

FIG. 13 is a flowchart illustrating a flow of operation of a likelihood ratio calculation unit in the information processing system according to the eighth example embodiment.

FIG. 14 is a flowchart illustrating a flow of operation of a classification apparatus in an information processing system according to a ninth example embodiment.

### DESCRIPTION OF EXAMPLE EMBODIMENTS

Hereinafter, an information processing system, an information processing method, and a computer program according to example embodiments will be described with reference to the drawings.

### First Example Embodiment

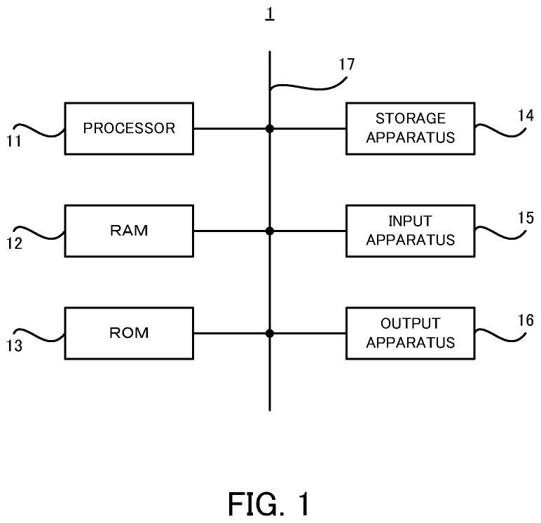

An information processing system according to a first example embodiment will be described with reference to FIG. 1 to FIG. 4.

### (Hardware Configuration)

First, a hardware configuration of the information processing system according to the first example embodiment will be described with reference to FIG. 1. FIG. 1 is a block diagram illustrating the hardware configuration of the information processing system according to the first example embodiment.

As illustrated in FIG. 1, an information processing system 1 according to the first example embodiment includes a processor 11, a RAM (Random Access Memory) 12, a ROM (Read Only Memory) 13, and a storage apparatus 14. The information processing system 1 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium by using a not-illustrated recording medium reading apparatus. The processor 11 may obtain (i.e., may read) a computer program from a not-illustrated apparatus disposed outside the information processing system 1, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for performing a classification using a likelihood ratio and a learning process related to the classification is realized or implemented in the processor 11. An example of the processor 11 includes a CPU (Central Processing Unit), a GPU (Graphics Processing Unit), a FPGA (field-programmable gate array), a DSP (Demand-Side Platform), and an ASIC (Application Specific Integrated Circuit). The processor 11 may use one of the examples described above, or may use a plurality of them in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the information processing system 1. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 1. The input apparatus 15 may include, for example, at least one of a keyboard, a mouse, and a touch panel. The input apparatus 15 may be a dedicated controller (operation terminal). The input apparatus 15 may also include a terminal owned by the user (e.g., a smartphone or a tablet terminal, etc.). The input apparatus 15 may be an apparatus that allows an audio input including a microphone, for example.

The output apparatus 16 is an apparatus that outputs information about the information processing system 1 to the outside. For example, the output apparatus 16 may be a display apparatus (e.g., a display) that is configured to display the information about the information processing system 1. The display apparatus here may be a TV monitor, a personal computer monitor, a smartphone monitor, a tablet terminal monitor, or another portable terminal monitor. The display apparatus may be a large monitor or a digital signage installed in various facilities such as stores. The output apparatus 16 may be an apparatus that outputs the information in a format other than an image. For example, the output apparatus 16 may be a speaker that audio-outputs the information about the information processing system 1.

### (Functional Configuration)

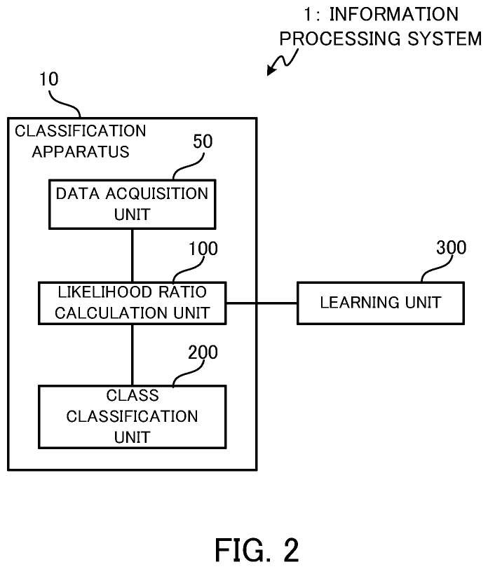

Next, a functional configuration of the information processing system 1 according to the first example embodiment will be described with reference to FIG. 2. FIG. 2 is a block diagram illustrating the functional configuration of the information processing system according to the first example embodiment.

As illustrated in FIG. 2, the information processing system 1 according to the first example embodiment includes a classification apparatus 10 and a learning unit 300. The classification apparatus 10 is an apparatus for performing class classification of inputted series data, and includes, as processing blocks for realizing the functions thereof, a data acquisition unit 50, a likelihood ratio calculation unit 100, and a class classification unit 200. Furthermore, the learning unit 300 is configured to perform a learning process related to the classification apparatus 10. Although the learning unit 300 is provided separately from the classification apparatus 10, the classification apparatus 10 may include the learning unit 300. Each of the data acquisition unit 50, the likelihood ratio calculation unit 100, the class classification unit 200, and the learning unit 300 may be realized or implemented by the processor 11 (see FIG. 1).

The data acquisition unit 50 is configured to obtain a plurality of elements included in the series data. The data acquisition unit 50 may directly obtain data from an arbitrary data acquisition apparatus (e.g., a camera, a microphone, etc.) or may read data obtained in advance by a data acquisition apparatus and stored in a storage or the like. When data are obtained from a camera, the data acquisition unit 50 may be configured to obtain data from each of a plurality of cameras. The elements of the series data obtained by the data acquisition unit 50 is configured to be outputted to the likelihood ratio calculation unit 100. The series data are data including a plurality of elements arranged in a predetermined order, and an example thereof is time series data, for example. A more specific example of the series data includes, but is not limited to, video data and audio data.

The likelihood ratio calculation unit 100 is configured to calculate a likelihood ratio on the basis of at least two consecutive elements of the plurality of elements obtained by the data acquisition unit 50. The “likelihood ratio” here is an index indicating a likelihood of a class to which the series data belong. A specific example of the likelihood ratio and a specific calculation method thereof will be described in detail in another example embodiment described later.

The class classification unit 200 is configured to classify the series data on the basis of the likelihood ratio calculated by the likelihood ratio calculation unit 100. The class classification unit 200 selects at least one class to which the series data belong, from among a plurality of classes that are classification candidates. The plurality of classes that are classification candidates may be set in advance. Alternatively, the plurality of classes that are classification candidates may be set by the user as appropriate, or may be set as appropriate on the basis of a type of the series data to be handled.

The learning unit 300 performs learning related to the calculation of the likelihood ratio, by using a loss function. Specifically, the learning unit 300 performs the learning related to the calculation of the likelihood ratio such that the class classification based on the likelihood ratio is accurately performed. The loss function used by the learning unit 300 according to this example embodiment is a loss function of a log-sum-exp type, and more specifically, it is a function including sum and exp in log. The loss function may be set in advance as a function that satisfies such a definition. A specific example of the loss function will be described in detail in another example embodiment described later.

### (Flow of Classification Operation)

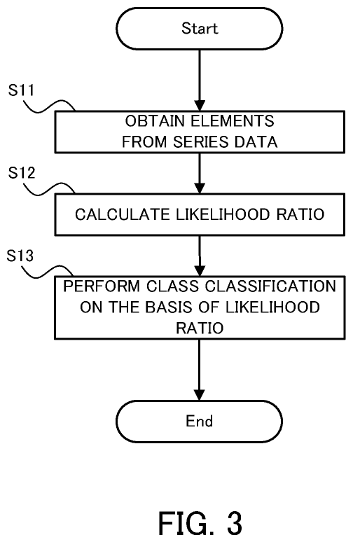

Next, with reference to FIG. 3, a flow of operation of the classification apparatus 10 in the information processing system 1 according to the first example embodiment (specifically, a class classification operation after the learning) will be described. FIG. 3 is a flowchart illustrating the flow of the operation of the classification apparatus in the information processing system according to the first example embodiment.

As illustrated in FIG. 3, when the operation of the classification apparatus 10 is started, first, the data acquisition unit 50 obtains elements included in the series data (step S11). The data acquisition unit 50 outputs the obtained elements of the series data to the likelihood ratio calculation unit 100. Then, the likelihood ratio calculation unit 100 calculates the likelihood ratio on the basis of the obtained two or more elements (step S12).

Subsequently, the class classification unit 200 performs class classification on the basis of the calculated likelihood ratio (step S13). The class classification may determine a single class to which the series data belong, or may determine a plurality of classes to which the series data are likely to belong. The class classification unit 200 may output a result of the class classification to a display or the like. The class classification unit 200 may output the result of the class classification by audio through a speaker or the like.

### (Flow of Learning Operation)

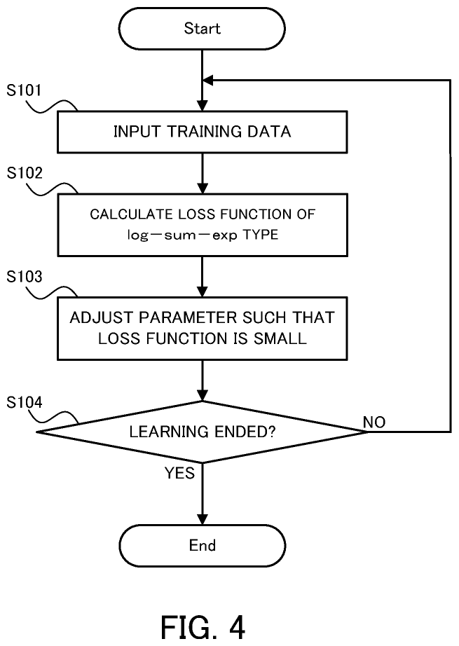

Next, a flow of operation of the learning unit 300 in the information processing system 1 according to the first example embodiment (i.e., a learning operation related to the calculation of the likelihood ratio) will be described with reference to FIG. 4. FIG. 4 is a flowchart illustrating the flow of the operation of the learning unit in the information processing system according to the first example embodiment.

As illustrated in FIG. 4, when the learning operation is started, first, training data are inputted to the learning unit 300 (step S101). The training data may be configured as a set of the series data and information about a correct answer class to which the series data belong (i.e., correct answer data), for example.

Subsequently, the learning unit 300 calculates the loss function by using the inputted training data (step S102). The loss function here is a loss function of a log-sum-exp type, as already described. The loss function of a log-sum-exp type is a loss function including sum (total sum) and exp (exponential function) in log, and a function such as log(Σ exp(x)), for example. Subsequently, the learning unit 300 adjusts a parameter (specifically, a parameter of a model for calculating the likelihood ratio) such that the calculated loss function is small (step S103). That is, the learning unit 300 optimizes the parameter of the model for calculating the likelihood ratio. As a method of optimizing the parameter using the loss function, it is possible to adopt existing techniques/technologies, as appropriate. An example of the optimization method is an error back propagation method, but another method may be also used.

Then, the learning unit 300 determines whether or not all the learning is ended (step S104). The learning unit 300 may determine whether or not all the learning is ended depending on whether or not all the training data are inputted, for example. Alternatively, the learning unit 300 may determine whether or not all the learning is ended depending on whether or not a predetermined period elapses from the start of the learning. Alternatively, the learning unit 300 may determine whether or not all the learning is ended depending on whether or not the steps S101 to S103 are looped a predetermined number of times.

When it is determined that all the learning is ended (step S104: YES), a series of processing steps is ended. On the other hand, when it is determined that all the learning is not ended (step S104:NO), the learning unit 300 starts the process from the step S101 again. By this, the learning process using the training data is repeated, and the parameter is adjusted to be optimal.

### Technical Effect

Next, a technical effect obtained by the information processing system 1 according to the first example embodiment will be described.

As described in FIG. 1 to FIG. 4, in the information processing system 1 according to the first example embodiment, the learning related to the calculation of the likelihood ratio used for the class classification is performed by the learning unit 300. Especially in this example embodiment, the learning is performed by using the loss function of a log-sum-exp type. According to the study of the inventors of the present application, it has been found that convergence properties in the stochastic gradient descent are improved by using the loss function of a log-sum-exp type for the learning of the likelihood ratio. More specifically, it is possible to assign a larger gradient to those which are relatively hard to perform the class classification using the likelihood ratio (e.g., hard class, hard frame, hard example), ad thus, it is possible to accelerate the convergence and to perform efficient learning. For example, the learning of a DNN (Deep Neural Network) takes a relatively long time; however, it is possible to perform highly efficient learning by increasing the convergence as described above.

As an existing technique/technology that can be used to learn those which are hard to classify, a technique/technology of weighting by multiplying the loss function by an appropriate coefficient (so-called Loss Weighting) is known, but this technique/technology requires empirical rules and tuning when determining the coefficient. Another technique of the learning performed by inputting data that are hard to classify, over and over again, allowing duplicates (so-called Oversampling) is also known, but simple data are less likely to appear in mini-batches, so that it requires many steps to see all the data, making the convergence slower. Alternatively, a method of relatively emphasizing data that are hard to classify, by deleting data that are easy to classify (so-called Undersampling) is also known, but since a part of the data is deleted, it is inevitable that the learning accuracy is degraded. If, however, the learning is performed by using the loss function of a log-sum-exp type described in this example embodiment, then, it is possible to perform efficient learning while solving the above-described problems.

### Second Example Embodiment

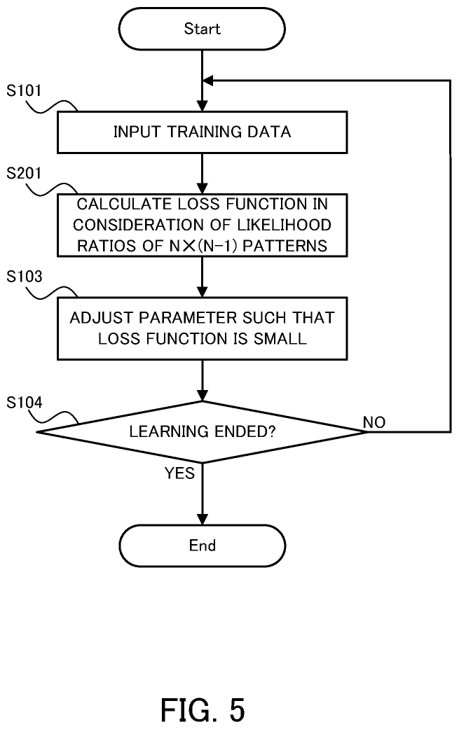

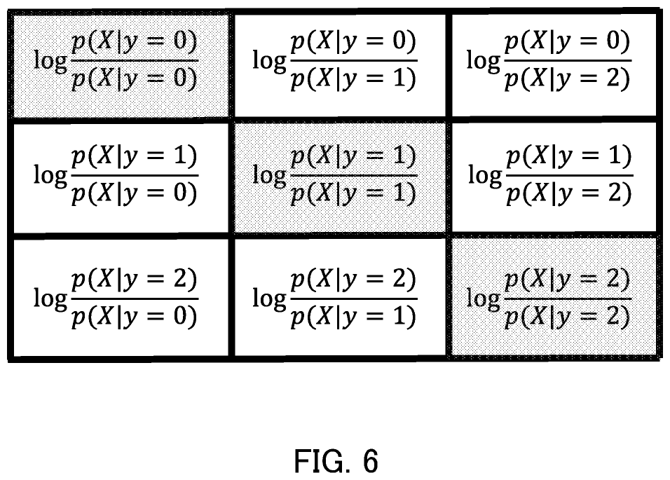

The information processing system 1 according to a second example embodiment will be described with reference to FIG. 5 and FIG. 6. The second example embodiment is partially different from the first example embodiment only in the operation, and may be the same as the first example embodiment in the apparatus configuration (see FIG. 1 and FIG. 2), the operation of the classification apparatus 10 (see FIG. 3), and the like, for example. For this reason, a part that is different from the first example embodiment will be described in detail below, and a description of other overlapping parts will be omitted as appropriate.

### (Flow of Learning Operation)

First, a flow of operation of the learning unit 300 in the information processing system 1 according to the second example embodiment will be described with reference to FIG. 5. FIG. 5 is a flowchart illustrating the flow of the operation of the information processing system according to the second example embodiment. In FIG. 5, the same steps as those illustrated in FIG. 4 carry the same reference numerals.

As illustrated in FIG. 5, when the operation of the information processing system 1 according to the second example embodiment is started, first, the training data are inputted to the learning unit 300 (step S101).

Subsequently, the learning unit 300 calculates the loss function by using the inputted training data, and especially in the second example embodiment, the learning unit 300 calculates the loss function that takes into account likelihood ratios of N×(N−1) patterns in which a denominator is a likelihood in which the series data belong to one class and a numerator is a likelihood in which the series data belong to another class, out of N classes (wherein N is a natural number) that are classification candidates of the series data (step S201). This loss function is a function in which the likelihood ratio increases when the correct answer class to which the series data belong is in the numerator of the likelihood ratio, and in which the likelihood ratio decreases when the correct answer class is in the denominator of the likelihood ratio. The loss function is also the loss function of a log-sum-exp type, as in the first example embodiment. The likelihood ratio to be considered in the loss function will be described later in detail with a specific example.

Subsequently, the learning unit 300 adjusts the parameter such that the calculated loss function is small (step S103). That is, the learning unit 300 optimizes the parameter of the model for calculating the likelihood ratio. Then, the learning unit 300 determines whether or not all the learning is ended (step S104). When it is determined that all the learning is ended (step S104: YES), a series of processing steps is ended. On the other hand, when it is determined that all the learning is not ended (step S104:NO), the learning unit 300 starts the process from the step S101 again.

### (Specific Examples of Likelihood Ratios to be Considered)

Next, with reference to FIG. 6, the likelihood ratios to be considered in the learning operation by the learning unit 300 (i.e., the likelihood ratios to be considered in the calculation of the loss function) will be specifically described. FIG. 6 is a matrix diagram illustrating an example of the likelihood ratios to be considered by the learning unit in the information processing system according to the second example embodiment.

As illustrated in FIG. 6, the likelihood is considered to be a matrix. For convenience of description, it is assumed that there are three classes that are classification candidates, which are a “class 0,” a “class 1,” and a “class 2.” p(X|y=0) is a likelihood indicating that the series data are in the “class 0”. p(X|y=1) is a likelihood indicating that the series data are in the “class 1”. p(X|y=2) is a likelihood indicating that the series data are in the “class 2”.

In a first row from the top of the matrix, the numerators of the log likelihood ratio (hereinafter simply referred to as “likelihood ratio”) are all p (X|y=0). In a second row from the top of the matrix, the numerators of the likelihood ratios are all p(X|y=1). In a third row from the top of the matrix, the numerators of the likelihood ratios are all p(X|y=2). On the other hand, in a first column from the left of the matrix, the denominators of the likelihood ratio are all p(X|y=0). In a second column from the left of the matrix, the denominators of the likelihood ratios are all p(X|y=1). In a third column from the left of the matrix, the denominators of the likelihood ratios are all p(X|y=2).

In the likelihood ratios on a diagonal line of the matrix (the likelihood ratio shaded in gray in FIG. 6), the denominator and the numerator have the same likelihood. Specifically, in each of log{p(X|y=0)/p(X|y=0)} in the first row from the top and the first column from the left, log{p(X|y=1)/p(X|y=1)} in the second row from the top and the second column from the left, and log{p(X|y=2)/p(X|y=2)} in the third row from the top and the third column from the left, the denominator is the same as the numerator. Furthermore, in the likelihood ratios located at a position facing each other across the likelihood ratios on the diagonal line, the denominator and the numerator are reversed to each other. Specifically, in log {p(X|y=0)/p(X|y=1)} in the first row from the top and the second column from the left and log {p(X|y=1)/p(X|y=0)} in the second row from the top and the first column from the left, the denominator and the numerator are reversed. Similarly, log {p(X|y=0)/p(X|y=2)} in the first row from the top and the third column from the left and log {p(X|y=2)/p(X|y=0)} in the third row from the top and the first column from the left, the denominator and the numerator are reversed. In log {p(X|y=1)/p(X|y=2)} in the second row from the top and the third column from the left and log {p(X|y=2)/p(X|y=1)} in the third row from the top and the second column from the left, the denominator and the numerator are reversed. Therefore, the likelihood ratios located at the position facing each other across the diagonal line, have opposite signs to each other. Thus, the likelihood ratios illustrated in the matrix are arranged like an alternating matrix.

In particular, the likelihood ratios on the diagonal line in which the denominator is the same as the numerator, are all log 1 and have values of zero. For this reason, the likelihood ratios on the diagonal line in which the denominator is the same as the numerator, have substantially meaning less values even when the loss function is considered. Therefore, the likelihood ratios on the diagonal line in which the denominator is the same as the numerator, are not considered in the loss function. The number of the remaining likelihood ratios, excluding the likelihood ratio on the diagonal line, is N×(N−1), wherein N is the number of classes. In this example embodiment, the likelihood ratios of these N×(N−1) patterns (i.e., the likelihood ratios excluding the likelihood ratios on the diagonal line in the matrix) are considered in the loss function. A specific example of loss function that takes into account the likelihood ratios of N×(N−1) patterns will be described in detail in another example embodiments described later.

### Technical Effect

Next, a technical effect obtained by the information processing system 1 according to the second example embodiment will be described.

As described in FIG. 5 and FIG. 6, in the information processing system 1 according to the second example embodiment, the learning is performed by using the loss function that takes into account the likelihood ratios of N×(N−1) patterns in which the denominator is a likelihood in which the series data belong to one class and the numerator is a likelihood in which the series data belong to another class. By using such a loss function, as in the first example embodiment, the learning can be performed such that a penalty increases when the class is an incorrect answer and the penalty decreases when the class is a correct answer. As a result, it is possible to properly select at least one class to which the series data belong, from among a plurality of classes that are classification candidates.

When there are a plurality of classes as the classification candidates (so-called, when a multiclass classification is performed), it is not easy to determine what type of likelihood ratio is considered at the time of learning (e.g., what ratio should be taken). By using the loss function described above, however, the magnitude of the likelihood ratio varies depending on whether the correct answer class is in the numerator of the likelihood ratio or in the denominator, and this changes an influence on the loss function. By using such a loss function, it is possible to properly perform the learning related to the calculation of the likelihood ratio in the multiclass classification. This makes it possible to realize a proper class classification. It is hard to determine what type of likelihood ratio should be considered at the time of learning, especially when there are three or more classes as the classification candidates. Therefore, the technical effect according to this example embodiment is remarkably exhibited when the classification candidates are three or more classes.

Furthermore, the loss function used in the second example embodiment is also the loss function of a log-sum-exp type, as in the first example embodiment. Therefore, it is possible to improve the convergence properties in the stochastic gradient descent, and consequently, it is possible to perform efficient learning.

### Third Example Embodiment

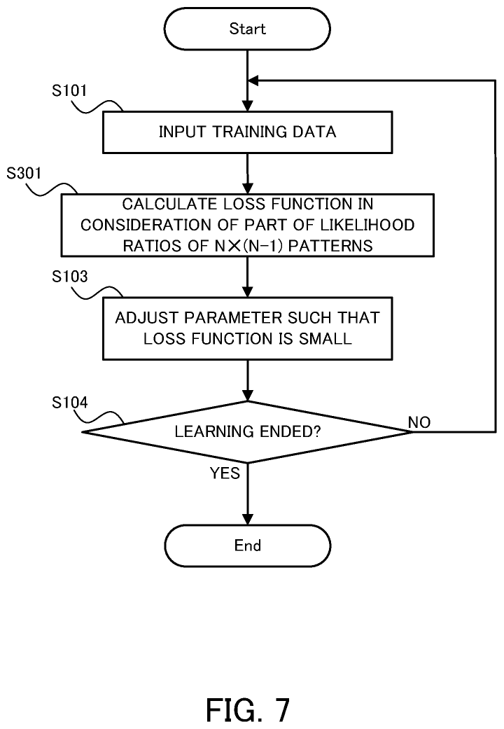

The information processing system 1 according to a third example embodiment will be described with reference to FIG. 7. The third example embodiment is partially different from the second example embodiment only in the operation, and may be the same as the second example embodiment in the other parts. For this reason, a part that is different from each of the example embodiments described above will be described in detail below, and a description of other overlapping parts will be omitted as appropriate.

### (Flow of Learning Operation)

First, a flow of operation of the learning unit 300 in the information processing system 1 according to the third example embodiment will be described with reference to FIG. 7. FIG. 7 is a flowchart illustrating the flow of the operation of the information processing system according to the third example embodiment. In FIG. 7, the same steps as those illustrated in FIG. 4 carry the same reference numerals.

As illustrated in FIG. 7, when the operation of the information processing system 1 according to the third example embodiment is started, first, the training data are inputted to the learning unit 300 (step S101).

Subsequently, the learning unit 300 calculates the loss function by using the inputted training data, and especially in the third example embodiment, the learning unit 300 calculates the loss function that takes into account a part of the likelihood ratios of N×(N−1)-patterns in which the denominator is a likelihood in which the series data belong to one class and the numerator is a likelihood in which the series data belong to another class, out of N classes that are classification candidates of the series data (step S301). That is, the learning unit 300 according to the third example embodiment considers not all, but a part of the likelihood ratios of N×(N−1) patterns described in the second example embodiment. As in the first example embodiment, this loss function is also a function in which the likelihood ratio increases when the correct answer class to which the series data belong is in the numerator of the likelihood ratio and the likelihood ratio decreases when the correct answer class is in the denominator of the likelihood ratio. The loss function is also the loss function of a log-sum-exp type, as in the first example embodiment.

Subsequently, the learning unit 300 adjusts the parameter such that the calculated loss function is small (step S103). Then, the learning unit 300 determines whether or not all the learning is ended (step S104). When it is determined that all the learning is ended (step S104: YES), a series of processing steps is ended. On the other hand, when it is determined that all the learning is not ended (step S104:NO), the learning unit 300 starts the process from the step S101 again.

### (Selection Example of the Likelihood Ratios to be Considered)

Next, a selection example of the likelihood ratios to be considered in the loss function (i.e., a selection example of a part of the likelihood ratios of N×(N−1)) patterns will be specifically described.

Out of the likelihood ratios of N×(N−1) patterns, a part of the likelihood ratios to be considered in the loss function may be selected in advance by the user or the like, or may be automatically selected by the learning unit 300. When the learning unit 300 selects a part of the likelihood ratio to be considered in the loss function, the learning unit 300 may select the likelihood ratios in accordance with a predetermined rule set in advance. Alternatively, the learning unit 300 may determine whether or not to make a selection on the basis of values of the calculated likelihood ratios.

A selection example of selecting a part of the likelihood ratios to be considered in the loss function is to select only the likelihood ratios in one row or one column of the matrix illustrated in FIG. 6. For example, as the likelihood ratios to be considered in the loss function, only the likelihood ratios in the first row of the matrix illustrated in FIG. 6 may be selected, only the likelihood ratios in the second row may be selected, or only the likelihood ratios in the third row may be selected. Alternatively, only the likelihood ratios in the first column of the matrix may be selected, only the likelihood ratios in the second column may be selected, or only the likelihood ratios in the third columns may be selected.

In addition, only the likelihood ratios in a part of a plurality of rows or a part of a plurality of columns of the matrix may be selected. Specifically, only the likelihood ratios in the first row and the second row of the matrix may be selected, only the likelihood ratios in the second row and the third row may be selected, or only the likelihood ratios in the third row and the first row may be selected. Alternatively, only the likelihood ratios in the first column and the second column of the matrix may be selected, only the likelihood ratios in the second column and the third column may be selected, or only the likelihood ratios in the third column and the first column may be selected.

The selection example of the likelihood ratios described above is only an example, and other likelihood ratios may be selected as the likelihood ratios to be considered in the loss function. For example, the likelihood ratios to be considered in the loss function may be randomly selected, regardless of the row and the column.

### Technical Effect

Next, a technical effect obtained by the information processing system 1 according to the third example embodiment will be described.

As described in FIG. 7, in the information processing system 1 according to the third example embodiment, the learning is performed by using the loss function that takes into account a part of the likelihood ratios, out of N×(N−1) patterns in which the denominator is a likelihood in which the series data belong to one class and the numerator is a likelihood in which the series data belong to another class. By using such a loss function, as in the second example embodiment, the learning can be performed such that the penalty increases when the class is an incorrect answer and the penalty decreases when the class is a correct answer. As a result, it is possible to properly select at least one class to which the series data belong, from among a plurality of classes that are classification candidates. Especially in the third example embodiment, by properly selecting the likelihood ratios to be considered in the loss function from among N×(N−1) patterns, it is possible to perform more efficient learning than that when all likelihood ratios of N×(N−1) patterns are considered. For example, it is possible to increase a learning efficiency by selecting only the likelihood ratio with a relatively large influence on the loss function and by not selecting the likelihood ratio with a relatively small influence on the loss function.

The loss function used in the third example embodiment is also the loss function of a log-sum-exp type, as in each of the example embodiments described above. Therefore, it is possible to improve the convergence properties in the stochastic gradient descent, and consequently, it is possible to perform more efficient learning.

### Fourth Example Embodiment

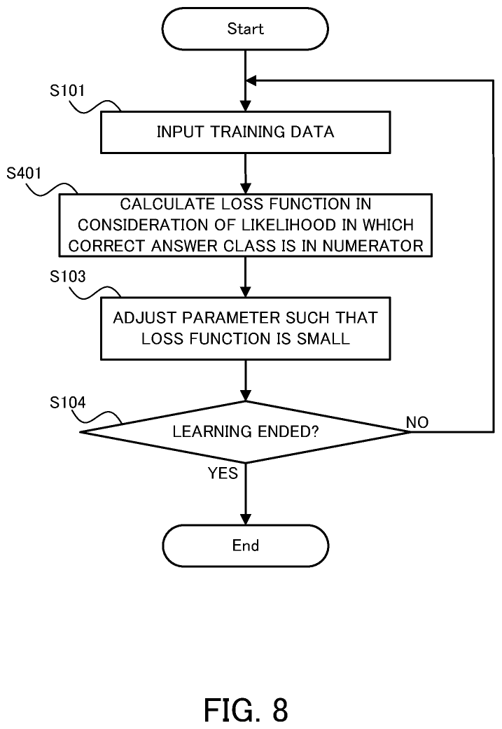

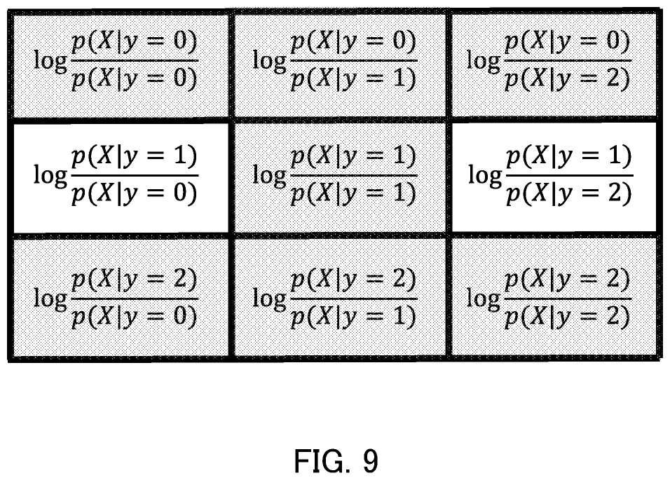

The information processing system 1 according to a fourth example embodiment will be described with reference to FIG. 8 and FIG. 9. The fourth example embodiment describes a specific selection example of the third example embodiment (i.e., a selection example of a part of the likelihood ratios to be considered in the loss function), and may be the same as the third example embodiment in the other parts. For this reason, a part that is different from each of the example embodiments described above will be described in detail below, and a description of other overlapping parts will be omitted as appropriate.

### (Flow of Learning Operation)

First, a flow of operation of the learning unit 300 in the information processing system 1 according to the fourth example embodiment will be described with reference to FIG. 8. FIG. 8 is a flowchart illustrating the flow of the operation of the information processing system according to the fourth example embodiment. In FIG. 8, the same steps as those illustrated in FIG. 4 carry the same reference numerals.

As illustrated in FIG. 8, when the operation of the information processing system 1 according to the fourth example embodiment is started, first, the training data are inputted to the learning unit 300 (step S101).

Subsequently, the learner 300 calculates the loss function by using the inputted training data, and especially in the fourth example embodiment, the learner 300 calculates the loss function that takes into account the likelihood ratio in which the correct answer class is present in the numerator, out of the likelihood ratios of N×(N−1) patterns described above (step S401). That is, the learning unit 300 according to the fourth example embodiment selects the likelihood ratio in which the correct answer class is in the numerator, as a part of the likelihood ratio of N×(N−1) patterns described in the third example embodiment. As in the second and third example embodiments, this loss function is also a function in which the likelihood ratio increases when the correct answer class to which the series data belong is in the numerator of the likelihood ratio and the likelihood ratio decreases when the correct answer class is in the denominator of the likelihood ratio. The loss function is also the loss function of a log-sum-exp type, as in the first example embodiment. A specific example of the loss function that takes into account the likelihood ratio in which the correct answer class is in the numerator will be described in detail in another example embodiments described later.

Subsequently, the learning unit 300 adjusts the parameter such that the calculated loss function is small (step S103). Then, the learning unit 300 determines whether or not all the learning is ended (step S104). When it is determined that all the learning is ended (step S104: YES), a series of processing steps is ended. On the other hand, when it is determined that all the learning is not ended (step S104:NO), the learning unit 300 starts the process from the step S101 again.

### (Specific Example of Likelihood Ratios to be Considered)

Next, with reference to FIG. 9, the likelihood ratios to be considered in the learning operation by the learning unit 300 (i.e., the likelihood ratios to be considered in the calculation of the loss function) will be specifically described. FIG. 9 is a matrix diagram illustrating an example of the likelihood ratios to be considered by the learning unit in the information processing system according to the fourth example embodiment.

In the matrix illustrated in FIG. 9, as already described in the second example embodiment (see FIG. 6), the likelihood ratios are arranged like an alternating matrix. The learning unit 300 according to the fourth example embodiment selects the likelihood ratio in which the correct answer class is in the numerator, from among the likelihood ratios of N×(N−1) patterns excluding the likelihood ratios on the diagonal line in such a matrix, and considers it in the loss function.

For example, it is assumed that the correct answer class of the series data inputted as the training data is the “class 1”. In this case, the learning unit 300 selects the likelihood ratio in which the class 1 is in the numerator from among the likelihood ratios of N×(N−1) patterns, and considers it in the loss function. Specifically, the learning unit 300 selects only the likelihood ratios in the second row from the top (excluding the likelihood ratios on the diagonal line) in FIG. 9, and considers them in the loss function. In this case, log {p(X|y=1)/p(X|y=0)} in the second row from the top and the first column from the left and log {p(X|y=1)/p(X|y=2)} in the second row from the top and the third column from the left are considered in the loss function. That is, the likelihood ratios that are not shaded in gray in FIG. 9 will be considered in the loss function.

When the correct answer class of the series data inputted as the training data is the “class 0”, the learning unit 300 may select the likelihood ratio in which the class 0 is in the numerator, from among the likelihood ratios of N×(N−1) patterns, and may consider it in the loss function. Specifically, the learning unit 300 may select only the likelihood ratios in the first row from the top (excluding the likelihood ratios on the diagonal line) in FIG. 9, and may consider them in the loss function. In this case, log {p(X|y=0)/p(X|y=1)} in the first row from the top and the second column from the left and log {p(X|y=0)/p(X|y=2)} in the first row from the top and the third column from the left are considered in the loss function.

Similarly, when the correct answer class of the series data inputted as the training data is the “class 2”, the learning unit 300 may select the likelihood ratio in which the class 2 is in the numerator, from among the likelihood ratios of N×(N−1) patterns, and may consider it in the loss function. Specifically, the learning unit 300 may select only the likelihood ratios in the third row from the top (excluding the likelihood ratios on the diagonal line) in FIG. 9, and may consider them in the loss function. In this case, log {p(X|y=2)/p(X|y=0)} in the third row from the top and the first column from the left and log {p(X|y=2)/p(X|y=1)} in the third row from the top and the second column from the left are considered in the loss function.

### Technical Effect

Next, a technical effect obtained by the information processing system 1 according to the fourth example embodiment will be described.

As described in FIG. 8 and FIG. 9, in the information processing system 1 according to the fourth example embodiment, the learning is performed by using the loss function that takes into account the likelihood ratio in which the correct answer class is in the numerator, out of N×(N−1) patterns. By using such a loss function, as in each of the example embodiments described above, proper learning is performed, and it is thus possible to properly select at least one class to which the series data belong, from among a plurality of classes that are classification candidates. Especially in the fourth example embodiment, the likelihood ratio in which the correct answer class is in the numerator (in other words, the likelihood ratio that may significantly influence the loss function) is considered in the loss function, and it is thus possible to perform more efficient learning than that when in which all likelihood ratios of N×(N−1) patterns are considered.

The loss function used in the fourth example embodiment is also the loss function of a log-sum-exp type, as in each of the example embodiments described above. Therefore, it is possible to improve the convergence properties in the stochastic gradient descent, and consequently, it is possible to perform more efficient learning.

### Fifth Example Embodiment

The information processing system 1 according to a fifth example embodiment will be described. The fifth example embodiment describes a specific example of the loss function used in the first to fourth example embodiments, and may be the same as the first to fourth example embodiments in the apparatus configuration and the flow of the operation. For this reason, a part that is different from each of the example embodiments described above will be described in detail below, and a description of other overlapping parts will be omitted as appropriate.

### (Specific Example of Loss Function)

The loss function of a log-sum-exp type used in the information processing system 1 according to the fifth example embodiment includes the following equation (1), for example. It is assumed that a data set (a set of data and a label) inputted is {Xi,yi}^{N}ᵢ₌₁.

$$\\ \begin{matrix}[ Equation 1 ] & \\ {L}_{LLLR} = log ( 1 + {\sum }_{i = 1}^{M} {\sum }_{t = 1}^{T} {\sum }_{l \neq {y}_{i}}^{K} exp ( - {λ}_{{y}_{i}^{l}}^{( t )} ( {X}_{i} ) ) ) & ( 1 )\end{matrix}$$

The equation (1) is a loss function corresponding to the configuration that takes into account the likelihood ratio in which the correct answer class is in the numerator, which is described in the fourth example embodiment. In Equation (1), K is the number of classes, M is the number of data, and T is a time series length. In addition, i is a subscript in a row direction, and l is a subscript in a column direction (i.e., subscripts indicating a row number and a column number in the matrix illustrated in FIG. 6 or the like). λ is the likelihood ratio, and in Equation (1), it represents a log likelihood ratio with a label y, in a k-th row and the first column, at a time t.

Equation (1) has a form of “log(Σ exp(x))” with sum in log, and a large gradient is assigned to what is dominant in sum in log. Thus, for example, the convergence in the stochastic gradient descent is faster than that in the loss function such as “Σ log(1+exp(x))” or “Σ log(x)”.

### (Deformed Example of Loss Function)

The loss function of the above equation (1) can be deformed as illustrated in the following equation (2).

$$\\ \begin{matrix}[ Equation 2 ] & \\ {L}_{LLLR} = \frac{1}{MT} {\sum }_{i = 1}^{M} {\sum }_{t = 1}^{T} log ( 1 + {\sum }_{l \neq {y}_{i}}^{K} exp ( - {λ}_{{y}_{i}^{l}}^{( t )} ( {X}_{i} ) ) ) & ( 2 )\end{matrix}$$

In Equation (2), two of the three sums in log in the equation (1), are out of log. As described above, when there are a plurality of sums in the loss function, at least one sum may be in log, and the remaining sums may be out of log.

When the loss function is deformed as in Equation (2), a plurality of variations occurs depending on which sum is put in log. For example, in Equation (2), only the sum about K is included in log, but only the sum about M may be included in log, or only the sum about T may be included in log. Alternatively, the two sums about M and T may be put in log, the two sums about M and K may be put in log, or the two sums about T and K may be put in log.

In the above variations, an influence on the convergence properties varies depending on which sum is placed in log. Therefore, the sum to be included in log may be determined in view of an influence of each term. Which loss function to use, including which sum is placed in log, may be set in advance. However, it may be configured such that the user selects which loss function to use, including which sum is placed in log.

### Technical Effect

Next, a technical effect obtained by the information processing system 1 according to the fifth example embodiment will be described.

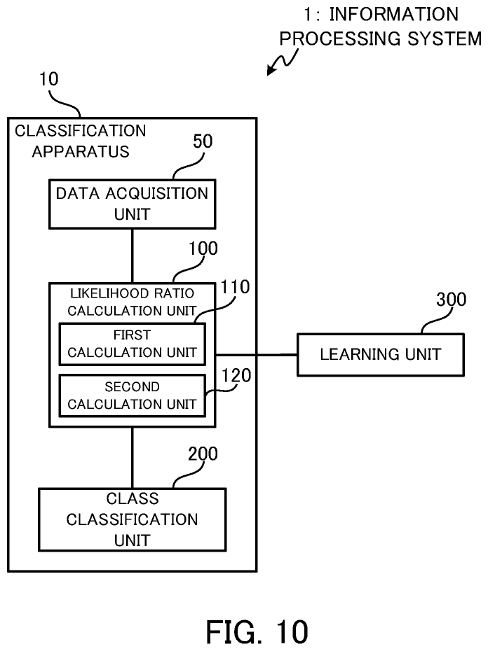

As described in FIG. 10, in the information processing system 1 according to the fifth example embodiment, the learning unit 300 uses the loss functions such as the Equations (1) and (2). Therefore, it is possible to improve the convergence properties in the stochastic gradient descent, and consequently, it is possible to perform more efficient learning. In addition, as in Equation (2), for the loss function including a plurality of sums, at least one of the sums is selected to be put in log, and the remaining sums are out of log, by which the influence on the convergence properties can be changed. As a consequence, it is possible to perform more efficient learning by properly setting which loss function to use, including which sum of the plurality of sums is placed in log.

### Sixth Example Embodiment

The information processing system 1 according to a sixth example embodiment will be described. As in the fifth example embodiment, the sixth example embodiment describes a specific example of the loss function used in the first to fourth example embodiments, and may be the same as the first to fourth example embodiments in the flow of apparatus configuration and operation. For this reason, a part that is different from each of the example embodiments described above will be described in detail below, and a description of other overlapping parts will be omitted as appropriate.

### (Specific Example of Loss Function)

The loss function of a log-sum-exp type used in the information processing system 1 according to the sixth example embodiment includes the following equation (3). It is assumed that a data set (a set of data and a label) inputted is {Xi,yi}^{N}ᵢ₌₁.

$$\\ \begin{matrix}[ Equation 3 ] & \\ {L}_{LLLR} = log [ {\sum }_{i = 1}^{M} {\sum }_{t = 1}^{T} {\sum }_{k = 1}^{k} {\sum }_{l \neq k}^{k} [ {δ}_{{ky}_{i}} ( 1 + exp ( {λ}_{kl}^{( t )} ( {X}_{i} ) ) ) + ( 1 - {δ}_{{ky}_{i}} ) ( 1 + exp ( - {λ}_{kl}^{( t )} ( {X}_{i} ) ) ) ] ] & ( 3 )\end{matrix}$$

Equation (3) is a loss function corresponding to the configuration that takes into account all the likelihood ratios of N×(N−1) patterns, which is described in the second example embodiment. In equation (3), K is the number of classes, M is the number of data, and T is the time series length. In addition, i is a subscript in the row direction, and l is a subscript in the column direction (i.e., subscripts indicating a row number and a column number in the matrix illustrated in FIG. 6 or the like). λ is the Kronecker delta, which is “1” when the subscripts match and which is “0” otherwise. λ is the likelihood ratio, and in Equation (3), it represents the log likelihood ratio with a label y, in a k-th row and the first column, at a time t.

Equation (3) has a form of “log(Σ exp(x))” with sum in log, and a large gradient is assigned to what is dominant in sum in log. Thus, for example, the convergence in the stochastic gradient descent is faster than that in the loss function such as “Σ log(1+exp(x))” or “Σ log(x)”.

### (Deformed Example of Loss Function)

The loss function of the above equation (3) can be deformed as illustrated in the following equation (4).

$$\\ \begin{matrix}[ Equation 4 ] & \\ {L}_{LLLR} = {\sum }_{i = 1}^{M} {\sum }_{t = 1}^{T} log [ {\sum }_{k = 1}^{k} {\sum }_{l \neq k}^{k} [ {δ}_{{ky}_{i}} ( 1 + exp ( {λ}_{kl}^{( t )} ( {X}_{i} ) ) ) + ( 1 - {δ}_{{ky}_{i}} ) ( 1 + exp ( - {λ}_{kl}^{( t )} ( {X}_{i} ) ) ) ] ] & ( 4 )\end{matrix}$$

In Equation (4), two of the four sums in log in the equation (3), are out of log. As described in the fifth example embodiment, when there are a plurality of sums in the loss function, at least one sum may be in log, and the remaining sums may be out of log.

### (Weighting Example)

The loss function may be weighted. For example, the weighting of Equation (4) results in the following equation (5).

$$\\ \begin{matrix}[ Equation 5 ] & \\ {L}_{LLLR} = {\sum }_{i = 1}^{M} {\sum }_{t = 1}^{T} {w}_{it} log [ {\sum }_{k = 1}^{k} {\sum }_{l \neq k}^{k} {w}_{itkl}^{′} [ {δ}_{{ky}_{i}} ( 1 + exp ( {λ}_{kl}^{( t )} ( {X}_{i} ) ) ) + ( 1 - {δ}_{{ky}_{i}} ) ( 1 + exp ( - {λ}_{kl}^{( t )} ( {X}_{i} ) ) ) ] ] & ( 5 )\end{matrix}$$

In Equation (5), wᵢₜ and w′ᵢₜₖₗ are weighting coefficients. The weighting coefficients may be values determined by empirical rules and tuning, for example. Furthermore, one of the weight coefficients wᵢₜ and w′ᵢₜₖₗ may be used to perform the weighting. The weighting of Equation (5) is only an example, and the weighting may be performed by multiplying a term that is different from those in the equation (5) by the weighting coefficients, for example.

Here, the example of weighting the loss function as illustrated in Equation (4) is described, but another loss function of a log-sum-exp type can be similarly weighted. For example, the weighting may be performed on Equation (3) before the deformation, and the weighting may be performed on Equation (1) and Equation (2) described in the fifth example embodiment.

### Technical Effect

Next, a technical effect obtained by the information processing system 1 according to the sixth example embodiment will be described.

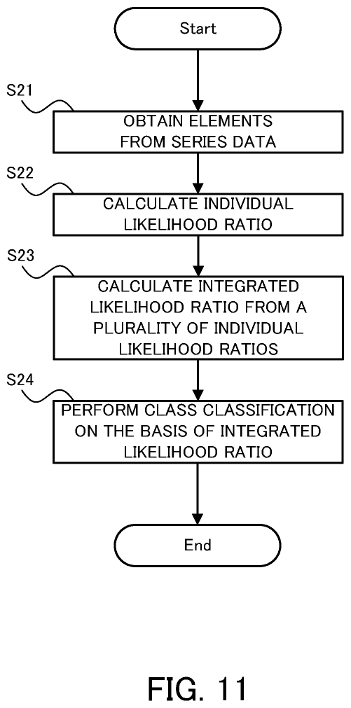

As described in FIG. 11, in the information processing system 1 according to the sixth example embodiment, the learning unit 300 uses the loss functions such as the Equations (3), Equations (4), and Equations (5). Therefore, it is possible to improve the convergence properties in the stochastic gradient descent, and consequently, it is possible to perform more efficient learning. It is also possible to perform more efficient learning by performing weighting as in Equation (5).

### Seventh Example Embodiment

The information processing system 1 according to a seventh example embodiment will be described with reference to FIG. 10 and FIG. 11. The seventh example embodiment is partially different from the first to sixth example embodiments only in the configuration and operation (specifically, the configuration and operation of the classification apparatus 10), and may be the same as the first to sixth example embodiments in the other parts. For this reason, a part that is different from each of the example embodiments described above will be described in detail below, and a description of other overlapping parts will be omitted as appropriate.

### (Functional Configuration)

First, a functional configuration of the information processing system 1 according to the seventh example embodiment will be described with reference to FIG. 10. FIG. 10 is a block diagram illustrating the functional configuration of the information processing system according to the seventh example embodiment. In FIG. 10, the same components as those illustrated in FIG. 2 carry the same reference numerals.

As illustrated in FIG. 10, in the information processing system 1 according to the seventh example embodiment, the likelihood ratio calculation unit 100 of the classification apparatus 10 includes a first calculation unit 110 and a second calculation unit 120. Each of the first calculation unit 110 and the second calculation unit 120 may be realized or implemented by the processor 11 (see FIG. 1), for example.

The first calculation unit 110 is configured to calculate an individual likelihood ratio on the basis of two consecutive elements included in the series data. The individual likelihood ratio is calculated as a likelihood ratio indicating a likelihood of a class to which two consecutive elements belong. The first calculation unit 110 may sequentially obtain elements included in the series data from the data acquisition unit 50, and sequentially calculate the individual likelihood ratio based on two consecutive elements, for example. The individual likelihood ratio calculated by the first calculation unit 110 is configured to be outputted to the second calculation unit 120.

The second calculation unit 120 is configured to calculate an integrated likelihood ratio on the basis of a plurality of individual likelihood ratios calculated by the first calculation unit 110. The integrated likelihood ratio is calculated as a likelihood ratio indicating a likelihood of a class to which a plurality of elements considered in each of the plurality of individual likelihood ratios belong. In other words, the integrated likelihood ratio is calculated as a likelihood ratio indicating a likelihood of a class to which the series data including a plurality of elements belong. The integrated likelihood ratio calculated by the second calculation unit 120 is configured to be outputted to the class classification unit 200. The class classification unit 200 performs the class classification of the series data on the basis of the integrated likelihood ratio.

The learning unit 300 according to the fifth example embodiment may perform the learning for the entire likelihood ratio calculation unit 100 (i.e., for the first calculation unit 110 and the second calculation unit 120 together), or may perform the learning separately for the first calculation unit 110 and the second calculation unit 120. Alternatively, the learning unit 300 may be separately provided as a first learning unit that performs the learning only the first calculation unit 110 and a second learning unit that performs the learning only the second calculation unit 120. In this case, only one of the first learning unit and the second learning unit may be provided.

### (Flow of Classification Operation)

Next, a flow of operation of the classification apparatus 10 in the information processing system 1 according to the seventh example embodiment (specifically, a class classification operation after the learning) will be described with reference to FIG. 11. FIG. 11 is a flowchart illustrating the flow of the operation of the classification apparatus in the information processing system according to the seventh example embodiment.

As illustrated in FIG. 11, when the operation of the classification apparatus 10 is started, first, the data acquisition unit 50 obtains elements included in the series data (step S21). The data acquisition unit 50 outputs the obtained elements of the series data to the first calculation unit 110.

Then, the first calculation unit 110 calculates the individual likelihood ratio on the basis of the obtained two consecutive elements (step S22). Then, the second calculation unit 120 calculates the integrated likelihood ratio on the basis of a plurality of individual likelihood ratios calculated by the first calculation unit 110 (step S23).

Subsequently, the class classification unit 200 performs the class classification on the basis of the calculated integrated likelihood ratio (step S24). The class classification may determine one class to which the series data belong, or may determine a plurality of classes to which the series data are likely to belong. The class classification unit 200 may output a result of the class classification to a display or the like. The class classification unit 200 may output the result of the class classification by audio through a speaker or the like.

### Technical Effect

Next, a technical effect obtained by the information processing system 1 according to the seventh example embodiment will be described.

As described in FIG. 10 and FIG. 11, in the information processing system 1 according to the seventh example embodiment, first, the individual likelihood ratio is calculated on the basis of two elements, and then, the integrated likelihood ratio is calculated on the basis of a plurality of individual likelihood ratios. By using the integrated likelihood ratio calculated in this manner, it is possible to properly select the class to which the series data belong. Furthermore, even in the classification apparatus 10 that calculates the individual likelihood ratio and the integrated likelihood ratio, it is possible to improve the convergence properties in the stochastic gradient descent by using the loss function of a log-sum-exp type described in each of the example embodiments described above. Therefore, it is possible to perform efficient learning.

### Eighth Example Embodiment

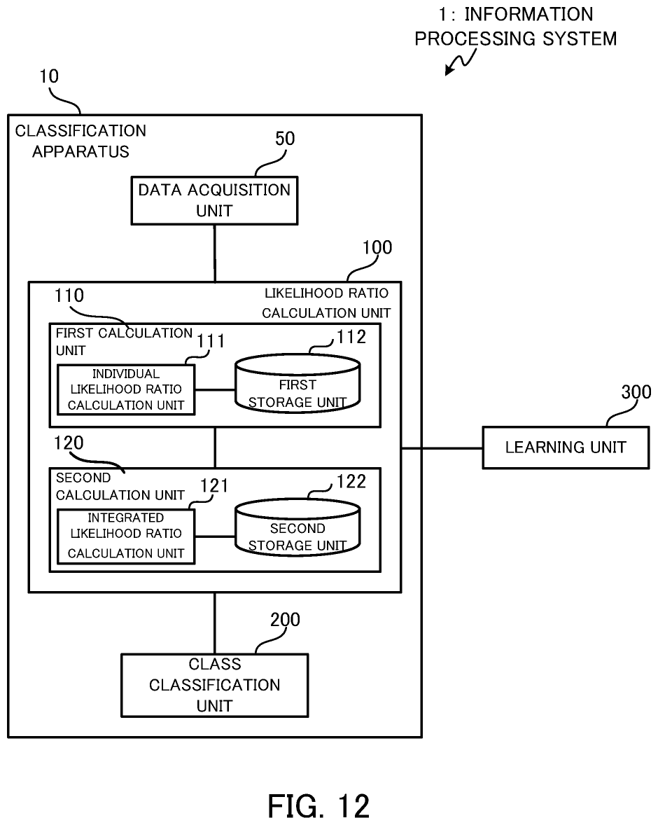

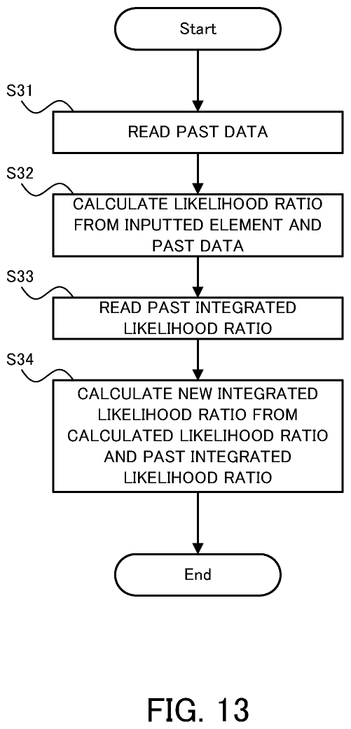

The information processing system 1 according to an eighth example embodiment will be described with reference to FIG. 12 and FIG. 13. The eighth example embodiment is partially different from the seventh example embodiment only in the configuration and operation (specifically, the configuration and operation of the likelihood ratio calculation unit 100), and may be the same as the seventh example embodiment in the other parts. For this reason, a part that is different from each of the example embodiments described above will be described in detail below, and a description of other overlapping parts will be omitted as appropriate.

### (Functional Configuration)

First, a functional configuration of the information processing system 1 according to the eighth example embodiment will be described with reference to FIG. 12. FIG. 12 is a block diagram illustrating the functional configuration of the information processing system according to the eighth example embodiment. In FIG. 12, the same components as those illustrated in FIG. 2 and FIG. 10 carry the same reference numerals.

As illustrated in FIG. 12, in the information processing system 1 according to the eighth example embodiment, the likelihood ratio calculation unit 100 of the classification apparatus 10 includes the first calculation unit 110 and the second calculation unit 120. The first calculation unit 110 includes an individual likelihood ratio calculation unit 111 and a first storage unit 112. The second calculation unit 120 includes an integrated likelihood ratio calculation unit 121 and a second storage unit 122. Each of the individual likelihood ratio calculation unit 111 and the integrated likelihood ratio calculation unit 121 may be realized or implemented by the processor 11 (see FIG. 1), for example. Furthermore, each of the first storage unit 112 and the second storage unit 122 may be realized or implemented by the storage apparatus 14 (see FIG. 1), for example.

The individual likelihood ratio calculation unit 111 is configured to calculate the individual likelihood ratio on the basis of two consecutive elements of the elements sequentially obtained by the data acquisition unit 50. More specifically, the individual likelihood ratio calculation unit 111 calculates the individual likelihood ratio on the basis of a newly obtained element and past data stored in the first storage unit 112. Information stored in the first storage unit 112 is configured to be read by the individual likelihood ratio calculation unit 111. When the first storage unit 112 stores the individual likelihood ratio of the past, the individual likelihood ratio calculation unit 111 reads the stored past individual likelihood ratios and calculates a new individual likelihood ratio in consideration of the obtained element. On the other hand, when the first storage unit 112 stores the element itself obtained in the past, the individual likelihood ratio calculation unit 111 may calculate the past individual likelihood ratio from the stored past element, and may calculate the likelihood ratio for the newly obtained element.

The integrated likelihood ratio calculation unit 121 is configured to calculate the integrated likelihood ratio on the basis of a plurality of individual likelihood ratios. The integrated likelihood ratio calculation unit 121 calculates a new integrated likelihood ratio by using the individual likelihood ratio calculated by the individual likelihood ratio calculation unit 111 and the integrated likelihood ratio of the past stored in the second storage unit 122. Information stored in the second storage unit 122 (i.e., the past integrated likelihood ratio) is configured to be read by the integrated likelihood ratio calculation unit 121.

### <Flow of Likelihood Ratio Calculation Operation>

Next, a flow of a likelihood ratio calculation operation (i.e., operation of the likelihood ratio calculation unit 100) in the information processing system 1 according to the eighth example embodiment will be described with reference to FIG. 13. FIG. 13 is a flowchart illustrating the flow of the operation of the likelihood ratio calculation unit in the information processing system according to the eighth example embodiment.

As illustrated in FIG. 13, when the likelihood ratio calculation operation by the likelihood ratio calculation unit 100 is started, first, the individual likelihood ratio calculation unit 111 of the first calculation unit 110 reads the past data from the first storage unit 112 (step S31). The past data may be a processing result of the individual likelihood ratio calculation unit 111 for the element obtained one time before the element obtained this time in the data acquisition unit 50 (in other words, the individual likelihood ratio calculated for the previous element), for example. Alternatively, the past data may be the element itself obtained one time before the element obtained in the acquisition.

Subsequently, the individual likelihood ratio calculation unit 111 calculates a new individual likelihood ratio (i.e., the individual likelihood ratio for the element obtained this time by the data acquisition unit 50) on the basis of the element obtained by the data acquisition unit 50 and the past data read from the first storage unit 112 (step S32). The individual likelihood ratio calculation unit 111 outputs the calculated individual likelihood ratio to the second calculation unit 120. The individual likelihood ratio calculation unit 111 may store the calculated individual likelihood ratio in the first storage unit 112.

Subsequently, the integrated likelihood ratio calculation unit 121 of the second calculation unit 120 reads the past integrated likelihood ratio from the second storage unit 122 (step S33). The past integrated likelihood ratio may be a processing result of the integrated likelihood ratio calculation unit 121 for the element obtained one time before the element obtained this time by the data acquisition unit 50 (in other words, the integrated likelihood ratio calculated for the previous element), for example.

Subsequently, the integrated likelihood ratio calculation unit 121 calculates a new integrated likelihood ratio (i.e., the integrated likelihood ratio for the element obtained this time by the data acquisition unit 50) on the basis of the likelihood ratio calculated by the individual likelihood ratio calculation unit 111 and the past integrated likelihood ratio read from the second storage unit 122 (step S34). The integrated likelihood ratio calculation unit 121 outputs the calculated integrated likelihood ratio to the class classification unit 200. The integrated likelihood ratio calculation unit 121 may store the calculated integrated likelihood ratio in the second storage unit 122.

### Technical Effect

Next, a technical effect obtained by the information processing system 1 according to the eighth example embodiment will be described.

As described in FIG. 12 and FIG. 13, in the information processing system 1 according to the eighth example embodiment, the individual likelihood ratio is calculated by using the past individual likelihood ratio, and then, the integrated likelihood ratio is calculated using the past integrated likelihood ratio. By using the integrated likelihood ratio calculated in this manner, it is possible to properly select the class to which the series data belong. Furthermore, even in the classification apparatus 10 that calculates the individual likelihood ratio and the integrated likelihood ratio by using the past data, it is possible to improve the convergence properties in the stochastic gradient descent by using the loss function of a log-sum-exp type described in each of the example embodiments described above. Therefore, it is possible to perform efficient learning.

### Ninth Example Embodiment

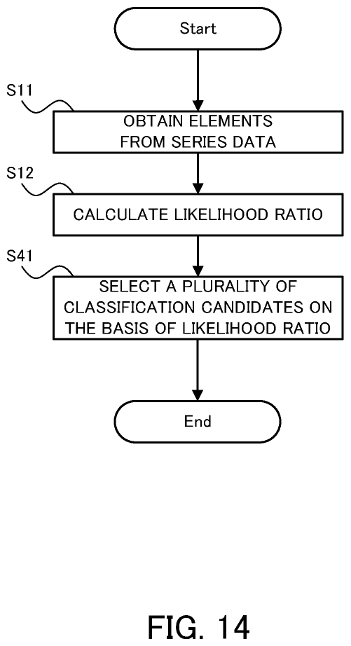

The information processing system 1 according to a ninth example embodiment will be described with reference to FIG. 14. The ninth example embodiment is partially different from the first to eighth example embodiments only in the operation (specifically, the operation of the class classification unit 200), and may be the same as the first to eighth example embodiments in the other parts. For this reason, a part that is different from each of the example embodiments described above will be described in detail below, and a description of other overlapping parts will be omitted as appropriate.

### (Flow of Classification Operation)

First, with reference to FIG. 14, a flow of operation of the classification apparatus 10 in the information processing system 1 according to the ninth example embodiment (specifically, a class classification operation after the learning) will be described. FIG. 14 is a flowchart illustrating the flow of the operation of the classification apparatus in the information processing system according to the ninth example embodiment. In FIG. 14, the same steps as those described in FIG. 3 carry the same reference numerals.

As illustrated in FIG. 14, when the operation of the classification apparatus 10 is started, first, the data acquisition unit 50 obtains elements included in the series data (step S11). The data acquisition unit 50 outputs the obtained elements of the series data to the likelihood ratio calculation unit 100. Then, the likelihood ratio calculation unit 100 calculates the likelihood ratio on the basis of the obtained two or more elements (step S12).

Subsequently, the class classification unit 200 performs the class classification on the basis of the calculated likelihood ratio, and especially in the ninth example embodiment, the class classification unit 200 selects and outputs a plurality of classes to which the series data may belong (step S41). That is, the class classification unit 200 does not determine one class to which the series data belong, but determines a plurality of classes to which the series data are likely to belong. More specifically, the class classification unit 200 performs a process of selecting k classes (wherein k is a natural number of n or less) from n classes that are prepared as classification candidates (where n is a natural number).

The class classification unit 200 may output informations about the k classes to which the series data may belong, to a display or the like. Furthermore, the class classification unit 200 may output the informations about the k classes to which the series data may belong, by audio through a speaker or the like.

When outputting the informations about the k classes to which the series data may belong, the class classification unit 200 may rearrange and output them. For example, the class classification unit 200 may output the informations about the k classes in descending order of the likelihood ratios. Alternatively, the class classification unit 200 may output each of the informations about the k classes in a different aspect for each class. For example, the class classification unit 200 may perform the output in a display aspect that highlights a class with a high likelihood ratio, while performing the output in a display aspect that does not highlight a class with a low likelihood ratio. In the highlighting, for example, a size or color to be displayed may be changed, or a movement may be given to an object to be displayed.

### Specific Application Examples

A configuration of outputting the k classes from the n classes described above will be described with some specific application examples.

### (Product Proposal)

The information processing system 1 according to the ninth example embodiment may be used to propose a product in which the user is likely to be interested, at a shopping site on a web. Specifically, the information processing system 1 may select k products (i.e., the k classes) in which the user is likely to be interested in, from n products (i.e., the n classes) that are handled products, and may output them to the user (wherein k is a number that is smaller than n). In this case, an example of the series data to be inputted is a past purchase history, browsing history, or the like.

Similarly, it may be used to propose a product and a store in digital signage or the like. In the digital signage, the image of the user may be captured by a mounted camera. In this case, the user's feeling may be estimated from the image of the user to propose a store or a product in accordance with the feeling. In addition, the user's line of sight may be estimated from the image of the user (i.e., the user's viewing area may be estimated) to propose a store or a product in which the user is likely to be interested. Alternatively, the user's attribute (e.g., gender, age, etc.) may be estimated from the image of the user to propose a store or a product in which the user is likely to be interested. When information about the user is estimated as described above, the n classes may be weighted in accordance with the estimated information.

### (Criminal Investigation)

The information processing system 1 according to the ninth example embodiment may also be used for crime investigation. For example, when a real criminal is to be found from among a plurality of suspects, selecting from them only a single person who is most likely the criminal may cause a big problem when the selection is wrong. In the information processing system 1 according to this example embodiment, however, it is possible to select and output high-ranking k suspects who are highly possibly the criminal. Specifically, classes corresponding to the high-ranking k suspects who are highly possibly the criminal may be selected and outputted from the series data including, as the element, information about each of the plurality of suspects. In this way, for example, a plurality of suspects who are highly possibly the criminal may be put under criminal investigation to properly find the real criminal.

### (Radar Image Analysis)

The information processing system 1 according to the ninth example embodiment may also be applied to the analysis of a radar image. Since most radar images are not clear by their nature, it is hard to accurately determine what is in the image only by machine, for example. In the information processing system 1 according to this example embodiment, however, k candidates that are likely to be in the radar image can be selected and outputted. Therefore, it is possible to firstly output the k candidates, from which the user can make a determination. For example, if a “dog,” a “cat,” a “ship,” and a “tank” are selected as candidates for what is in a radar image of a port, the user can easily determine that the “ship” that is highly related to the port, is in the radar image.

The application example described above are an example, and in a situation in which it is required to select the k candidates from the n candidates, it is possible to achieve a beneficial effect by applying the information processing system 1 according to this example embodiment.

A processing method in which a program for allowing the configuration in each of the example embodiments to operate to realize the functions of each example embodiment is recorded on a recording medium, and in which the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes process alone, but also the program that operates on an OS and executes process in cooperation with the functions of expansion boards and another software, is also included in the scope of each of the example embodiments.

This disclosure is not limited to the examples described above and is allowed to be changed, if desired, without departing from the essence or spirit of this disclosure which can be read from the claims and the entire specification. An information processing system, an information processing method, and a computer program with such changes are also intended to be within the technical scope of this disclosure.

### <Supplementary Notes>

The example embodiments described above may be further described as, but not limited to, the following Supplementary Notes.

### (Supplementary Note 1)

An information processing system according to Supplementary Note 1 is an information processing system including: an acquisition unit that obtains a plurality of elements included in series data; a calculation unit that calculates a likelihood ratio indicating a likelihood of a class to which the series data belong, on the basis of at least two consecutive elements of the plurality of elements; a classification unit that classifies the series data into at least one class of a plurality of classes that are classification candidates, on the basis of the likelihood ratio; and a learning unit that performs learning related to calculation of the likelihood ratio, by using a loss function of a log-sum-exp type.

### (Supplementary Note 2)

An information processing system according to Supplementary Note 2 is the information processing system according to Supplementary Note 1, wherein the learning unit performs the learning by using a loss function that takes into account the likelihood ratios of N×(N−1) patterns in which a denominator is a likelihood in which the series data belong to one class and a numerator is a likelihood in which the series data belong to another class, out of N classes (wherein N is a natural number) that are classification candidates of the series data.

### (Supplementary Note 3)

An information processing system according to Supplementary Note 3 is the information processing system according to Supplementary Note 2, wherein the learning unit performs the learning by using a loss function that takes into account a part of the likelihood ratios of the N×(N−1) patterns.

### (Supplementary Note 4)

An information processing system according to Supplementary Note 4 is the information processing system according to Supplementary Note 3, wherein the learning unit performs the learning by using a loss function that takes into account the likelihood ratio in which a correct answer class is in the numerator, out of the N×(N−1)-patterns.

### (Supplementary Note 5)

An information processing system according to Supplementary Note 5 is the information processing system according to any one of Supplementary Notes 1 to 4, wherein the loss function includes a plurality of sums and includes at least one of the plurality of sums in the log-sum-exp type.

### (Supplementary Note 6)

An information processing system according to Supplementary Note 6 is the information processing system according to any one of Supplementary Notes 1 to 5, wherein the loss function includes a weighting coefficient in accordance with a difficulty in classifying the series data.

### (Supplementary Note 7)

An information processing system according to Supplementary Note 7 is the information processing system according to any one of Supplementary Notes 1 to 6, wherein the likelihood ratio is an integrated likelihood ratio that is calculated by taking into account a plurality of individual likelihood ratios that are calculated on the basis of two consecutive elements included in the series data.

### (Supplementary Note 8)

An information processing system according to Supplementary Note 8 is the information processing system according to Supplementary Note 7, wherein the acquisition unit sequentially obtains a plurality of elements included in the series data, and the calculation unit calculates a new integrated likelihood ratio by using the individual likelihood ratio that is calculated on the basis of the newly obtained element and the integrated likelihood ratio calculated in the past.

### (Supplementary Note 9)

An information processing method according to Supplementary Note 9 is an information processing method including: obtaining a plurality of elements included in series data; calculating a likelihood ratio indicating a likelihood of a class to which the series data belong, on the basis of at least two consecutive elements of the plurality of elements; classifying the series data into at least one class of a plurality of classes that are classification candidates, on the basis of the likelihood ratio; and performing learning related to calculation of the likelihood ratio, by using a loss function of a log-sum-exp type.

### (Supplementary Note 10)

A computer program according to Supplementary Note 10 is a computer program that operates a computer: to obtain a plurality of elements included in series data; to calculate a likelihood ratio indicating a likelihood of a class to which the series data belong, on the basis of at least two consecutive elements of the plurality of elements; to classify the series data into at least one class of a plurality of classes that are classification candidates, on the basis of the likelihood ratio; and to perform learning related to calculation of the likelihood ratio, by using a loss function of a log-sum-exp type.

### (Supplementary Note 11)

A recording medium described in Supplementary Note 11 is a recording medium on which the computer program described in Supplementary Note 10 is recorded.

### DESCRIPTION OF REFERENCE CODES

1 Information processing system
11 Processor
14 Storage apparatus
10 Classification apparatus
50 Data acquisition unit
100 Likelihood ratio calculation unit
110 First calculation unit
111 Individual likelihood ratio calculation unit
112 First storage unit
120 Second calculation unit
121 Integrated likelihood ratio calculation unit
122 Second storage unit
200 Class classification unit
300 Learning unit

What is claimed is:

1. An information processing system comprising:
at least one memory that is configured to store instructions; and
at least one processor that is configured to execute the instructions to
obtain a plurality of elements included in series data;
calculate a likelihood ratio indicating a likelihood of a class to which the series data belong, on the basis of at least two consecutive elements of the plurality of elements;
classify the series data into at least one class of a plurality of classes that are classification candidates, on the basis of the likelihood ratio; and
perform learning related to calculation of the likelihood ratio, by using a loss function of a log-sum-exp type.

2. The information processing system according to claim 1, wherein the at least one processor is configured to execute the instructions to perform the learning by using a loss function that takes into account the likelihood ratios of N×(N−1) patterns in which a denominator is a likelihood in which the series data belong to one class and a numerator is a likelihood in which the series data belong to another class, out of N classes (wherein N is a natural number) that are classification candidates of the series data.

3. The information processing system according to claim 2, wherein the at least one processor is configured to execute the instructions to perform the learning by using a loss function that takes into account a part of the likelihood ratios of the N×(N−1) patterns.

4. The information processing system according to claim 3, wherein the at least one processor is configured to execute the instructions to perform the learning by using a loss function that takes into account the likelihood ratio in which a correct answer class is in the numerator, out of the N×(N−1)-patterns.

5. The information processing system according to claim 1, wherein the loss function includes a plurality of sums and includes at least one of the plurality of sums in the log-sum-exp type.

6. The information processing system according to claim 1, wherein the loss function includes a weighting coefficient in accordance with a difficulty in classifying the series data.

7. The information processing system according to claim 1, wherein the likelihood ratio is an integrated likelihood ratio that is calculated by taking into account a plurality of individual likelihood ratios that are calculated on the basis of two consecutive elements included in the series data.

8. The information processing system according to claim 7, wherein
The at least one processor is configured to execute the instructions to sequentially obtain a plurality of elements included in the series data, and
The at least one processor is configured to execute the instructions to calculate a new integrated likelihood ratio by using the individual likelihood ratio that is calculated on the basis of the newly obtained element and the integrated likelihood ratio calculated in the past.

9. An information processing method comprising:
obtaining a plurality of elements included in series data;
calculating a likelihood ratio indicating a likelihood of a class to which the series data belong, on the basis of at least two consecutive elements of the plurality of elements;
classifying the series data into at least one class of a plurality of classes that are classification candidates, on the basis of the likelihood ratio; and
performing learning related to calculation of the likelihood ratio, by using a loss function of a log-sum-exp type.

10. A non-transitory recording medium on which a computer program that allows a computer to execute an information processing method is recorded, the information processing method including:
obtaining a plurality of elements included in series data;
calculating a likelihood ratio indicating a likelihood of a class to which the series data belong, on the basis of at least two consecutive elements of the plurality of elements;
classifying the series data into at least one class of a plurality of classes that are classification candidates, on the basis of the likelihood ratio; and
performing learning related to calculation of the likelihood ratio, by using a loss function of a log-sum-exp type.
